(19) United States
(12) Patent Application Publication
(10) Pub. No.: US 2003/0004822 A1
(43) Pub. Date: Jan. 2, 2003

(54) Method and apparatus for integrated multi-channel retailing

(75) Inventors: David U. Shorter, Denton, TX (US); Filip J. Yeskel, Raleigh, NC (US)

Correspondence Address: Gregory A. Nelson, Akerman Senterfitt, 222 Lakeview Avenue, Fouth Floor, P.O. Box 3188, West Palm Beach, FL, 33402-3188, US

(73) Assignee: Internatioanl Business Machines Corporation, Armonk, NY

(21) Appl. No.: 09/896,771

(22) Filed: Jun. 29, 2001

(51) Int. Cl. G06F 17/60

(52) U.S. Cl. 705/26

(57) ABSTRACT

A method for integrating multi-channel retailing can include distributing and replicating selected data across retail channels via asynchronously transmitted messages in a common data format. The method can include the steps of: intercepting data processing messages in a retail IT system for use in one type of retail channel; formatting data in the intercepted messages using a user-definable markup language; and, asynchronously communicating the formatted data to at least one other retail IT system for use in at least one other type of retail channel. Notably, the user definable markup language can be XML. In one aspect of the invention, each converted data processing message can be asynchronously forwarded to a data control point; and, the forwarded messages can be asynchronously routed in the data control point to the others of the retail IT systems.

### BACKGROUND OF THE INVENTION

1. Technical Field

This invention relates generally to e-commerce and more specifically to retail information technology systems.

2. Description of the Related Art

A retail channel is a type of retail distribution outlet. Typically, retailers have utilized mostly two retail channels-physical, brick and mortar store locations and catalog outlets such as mail order and/or phone order outlets. In most cases, retailers provide separate, but redundant information technology (IT) systems in each retail channel. Historically, this separate IT system design is simpler to operate because there is no need to integrate two often distinct, disparate systems.

Nevertheless, the use of separate IT systems for multiple retail channels has created logistical problems for consumers who interact with a multi-channel retail operation. In particular, problems arise where each of the two distinct IT systems fail to communicate effectively. In consequence, consumers are compelled to redundantly interact with two separate IT systems despite the fact that a single retailer operates both systems. This has proven inconvenient for consumers.

For instance, retail IT systems include data associated with store merchandise, store orders, and store customer data. For each disparate IT system operated by a retailer in a particular retail channel, this type of data must be collected. Because individual retail IT systems of different retail channels cannot communicate with one another, the retail IT systems cannot access previously entered data. Hence, for each retail channel, data must be recollected. Consequently, consumers tend to view each retail channel as being operated by separate retailers sharing a common brand name.

There have recently been introduced a variety of new retail channels which have exacerbated the problem of multi-channel retailing. In particular, retailers have established an on-line retail channel via Internet-based storefronts on the World Wide Web (Web). These storefronts can be accessed not only through traditional means such as through a desktop computer operating a Web browser, but also through alternative means such as pervasive computing devices operating micro-browsers such as digital cellular telephones and personal communication systems, personal digital assistants and other types of handheld computing devices. Hence, retailers today can simultaneously operate physical store locations, catalog stores, on-line stores, and kiosks. Still, on-line stores implemented through the Web have IT systems and data that are largely independent of other retail channels operated by the retailer.

The proliferation of multi-channel retailing has created a significant problem for retailers, since it is impractical for retailers to operate separate IT systems for many retail channels. The consumer, as well as the retailer, would prefer shared data and common function across all retail channels. In particular, the consumer often must interact with the retailer for such functions as shopping, querying order status, picking-up merchandise, returning merchandise, changing contact information, and the like. This information must be communicated across all retail channels. Retailers, however, are reluctant to relinquish their significant investment in current separate IT systems, and to make significant investments in an integrated multi-channel IT system.

To combat the problem of separate, disparate retail channel IT systems, retailers have implemented synchronous messaging systems in multi-channel IT systems arranged in a client-server topology which permit real-time exchanges of data between the separate retail channel IT systems in a multi-channel retailing system. For instance, systems disclosed in U.S. Pat. Nos. 6,154,738 to Call, 6,115,641 to Brown et al., 6,161,122 to Hawkes, 5,860,068 to Cook, 5,857,156 to Anderson, and in Published PCT Patent Application WO 00/23929 each illustrate on-line client-server IT systems which rely upon synchronous communications. In particular, the Call system relates to a method and apparatus for disseminating over the Internet product information produced and maintained by product manufacturers.

In the Call system, a universal product code can be used in a client-server system as a key to access corresponding product information. Internet request messages containing the universal product code can be transmitted synchronously to a cross-referencing resource such as an HTTP server, LDAP server, or DNS server. Based on the universal product code, the cross-referencing resource can return an Internet address from which information regarding the product can be obtained.

Still, synchronous communications employed in a client-server architecture, such as that employed by the Call system, require available bandwidth, and in general, reliable communications conditions. Also, client-server architectures require coordinated logic which can inhibit integrating existing single-channel IT systems in a multi-channel IT system. Additionally, synchronous communications can be expensive in that the computational burden of processing synchronous communications can exceed the capacity of the synchronous messaging system. Finally, synchronous communications are not suited to adapt to arbitrary network conditions. Thus, what is needed is a reliable system and method for multi-channel retailing.

### SUMMARY OF THE INVENTION

A method for integrated multi-channel retailing can include the steps of: associating a plurality of message adaptors with corresponding retail integrated technology (IT) systems for processing common data in a plurality of retail channels, the association forming a peer-to-peer network; intercepting in the adaptors data processing messages generated in the corresponding retail IT systems; converting in the adaptors the intercepted data processing messages to a common message format and forwarding each converted data processing message others of the retail IT systems. Finally, the forwarded data processing messages can be received in adaptors associated with said others of said retail IT systems, converted a message format which can be processed in said others of said retail IT systems, and forwarded to the others of the retail IT systems.

Importantly, the peer-to-peer architecture of the present invention, unlike the client-server architecture of the prior art, allows significant autonomy among the retail IT systems. Moreover, by replicating data via data processing messages across multiple retail IT systems, even though each data processing message can originate in only one retail IT system, performance in each retail IT system can be enhanced. That is, when compared to remotely stored data, locally stored data, regardless of its source, results in substantially quicker access to data. Finally, the replication model of the present invention can provide the advantages of high availability well-known in the art.

The common message format can be a format based upon a user definable mark-up language. Additionally, the user definable mark-up language can be the extensible markup language (XML). The forwarding step can include the steps of: forwarding each converted data processing message to a data control point; and, routing the forwarded messages in the data control point to the others of the retail IT systems. The method can further include the step of queuing the intercepted messages in message queues in the adaptors prior to converting the messages to a common data format. Alternatively, the method can further include the step of queuing the converted messages in message queues in the adaptors prior to forwarding the messages to the others of the retail IT systems.

A method for integrated multi-channel retailing also can include the steps of: intercepting data processing messages in a retail IT system for use in one type of retail channel; formatting data in the intercepted messages using a user-definable markup language, and asynchronously communicating the formatted data to at least one other retail IT system for use in at least one other type of retail channel, Finally, asynchronously communicated formatted data can be received from at least one other retail IT system, and converted to a format which can be processed in the retail IT system for use in the one type of retail channel.

The user definable markup language can be XML. The asynchronously communicating step can include the steps of: asynchronously forwarding each converted data processing message to a data control point; and, asynchronously routing the forwarded messages in the data control point to the others of the retail IT systems. The step of asynchronously communicating the formatted data to at least one other retail IT system for use in at least one other type of retail channel step also can include the steps of: queuing the formatted messages in a message queue; and, incrementally forwarding each the queued messages to the others of the retail IT systems.

Finally, a multi-channel retailing method can include detecting a modification to common data in a retail IT system configured for use in a retail channel; formatting a message encapsulating the detected modification to the common data, and forwarding the formatted message to other retail IT systems configured for use in other retail channels. Also, formatted messages can be received which encapsulate modifications to common data. The common data can be extracted from the formatted message, and the extracted data can be formatted into a format which can be processed in the retail IT system configured for use in the one type of retail channel. Finally, the formatted data can be forwarded to the retail IT system.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is a schematic diagram of a peer-to-peer multi-channel retailing system utilizing asynchronous communications; and,

FIG. 2 is a schematic diagram of a peer-to-peer multi-channel retailing system utilizing asynchronous communications and a data control point in accordance with the inventive arrangements.

### DETAILED DESCRIPTION OF THE PREFERRED EMBODIMENTS

The invention provides a peer-to-peer method for adapting disparate IT systems corresponding to different retail channels so that all disparate IT systems asynchronously can share data and common function across all retail channels. Data can include customer information, product information and the like. In the present invention, consumers interacting with multiple retail channels seamlessly can access such functions as shopping, querying order status, picking-up merchandise, returning merchandise, changing contact information, and the like.

The present invention can provide such seamless access to those retailing functions without requiring retailers to relinquish their significant investment in current separate IT systems, and to make significant investments in an integrated multi-channel IT system. Moreover, asynchronous communications techniques are utilized in order to overcome the deficiencies of synchronous communications.

According to the present invention, one or more retail channels having associated IT systems can be arranged in a peer-to-peer topology. An adapter can be provided and associated with each IT system. The adapter can be configured to convert proprietary messages from an associated IT system corresponding to a particular retail channel to a common message format. Specifically, the adapter can format each proprietary message using a user definable mark-up language such as the Extensible Markup Language (XML). Once converted, messages can be transmitted asynchronously between and among at least one other IT system corresponding to at least one other retail channel.

The retail channels can be any suitable retail channel, whether currently in existence or hereafter devised. Examples, without limitation, of suitable retail channels include physical store locations, catalog stores, both mail order and phone order, on-line stores, kiosks, and pervasive computing device gateways for use with limited function computers such as personal digital assistants and cellular telephones. The user definable mark-up language can be any suitable language. In one aspect, of the present invention, the user definable mark-up language is the Extensible Markup Language (XML).

Notably, the adapters of the present invention can include computer program logic for converting messages from a format which can be processed by an associated IT system, to a common message format. Specifically, the adapter can identify the pertinent data in a message intercepted in an associated IT system, and can reformat the pertinent data using a common message format by formatting the pertinent data using tags and other data identifiers provided by the common user definable mark-up language. Conversely, the adapter can parse messages received in a message queue which have been formatted using the common message format and reformat the pertinent data in a manner recognizable by the associated IT system.

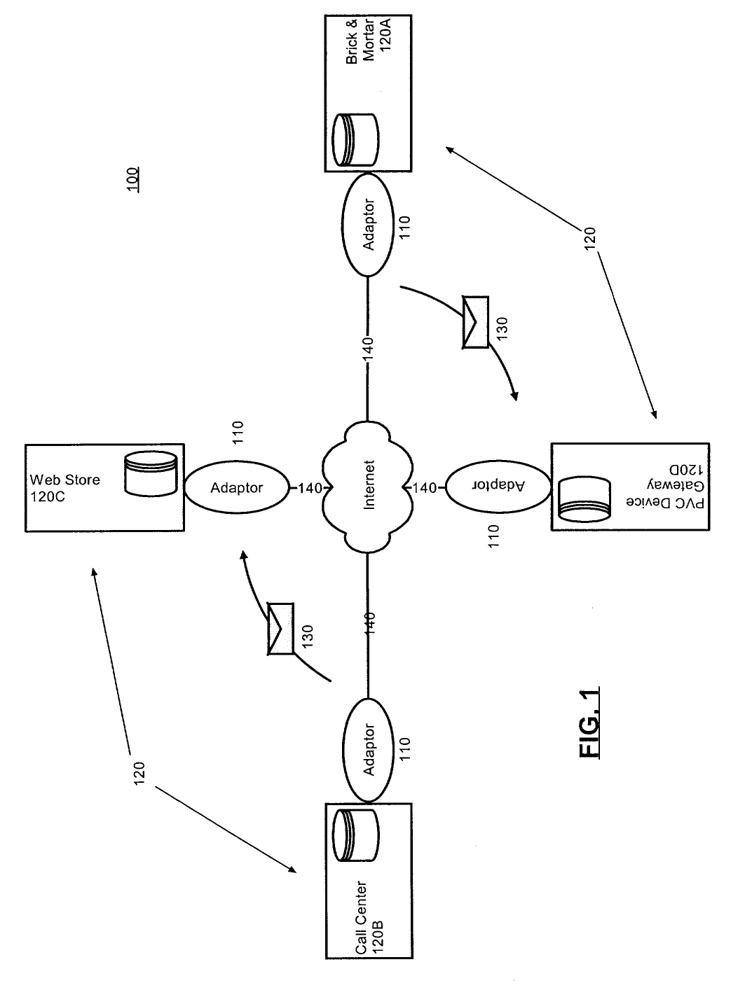

FIG. 1 is a schematic diagram of a peer-to-peer multi-channel retailing system utilizing asynchronous communications. The system 100 comprises multiple retail channels 120 such as brick-and-mortar stores 120A, catalog call center 120B, Web storefront 120C, and pervasive device gateway 120D. The invention further has utility with other retail channels that are not shown, as well as more or fewer retail channels than are shown in FIG. 1. Each retail channel 120 has associated therewith an adapter 110. Each adapter 110 can be configured for use with the particular retail channel 120 with which it operates. The adapter 110 can convert messages 130 from a format associated with the respective retail channel 120 to a common data format such as the user definable mark-up language, XML. Conversely, the adapter 110 can convert XML messages that are received from other adapters 110 in the system 100 so as to be useable by the respective associate retail channel 120.

Notably, the messages 130 can be asynchronously transmitted from retail channel 120 to retail channel 120 through suitable data transmission peer-to-peer connections 140. The asynchronous communications between each retail channel 120 can be facilitated by internal tables which indicate the physical and logical network location of other retail channels 120. Notably, a message queue can be used as an asynchronous means of communications. Asynchronous messaging adjusts easily to an arbitrarily wide range of communication speeds and availability. Also, the computational burden, and hence the cost, of synchronous communications exceeds that of messaging systems. The invention thus couples the cost of flexibility advantages of message-based communications with distributable data so as to simultaneously enable low cost, high adaptability, and high performance.

XML is a markup language which has been designed for data exchange among disparate sources. XML includes the significant advantages of being a worldwide, standard meta-language, having native support for receipt, storage, and generation among an increasing number of commercially off-the-shelf database products, and is supported by an increasing number of commercially available software tools. The system in one aspect operates utilizing XML formatting asynchronous messaging. The system utilizes a set of XML elements and attributes contained in various message definitions that constitute a virtual XML data model for the exchange of retail information.

The adapter 110 can be implemented for each retail channel 120 in order to provide communications with other retail channels 120 and to synchronize critical data across a multiplicity of different physical databases associated with the retail channels 120. In one aspect of the present invention, the adapter 110 can include an MQSeries Message Queue manager manufactured by International Business Machines Corporation of Armonk, N.Y., U.S.A. The adapter 110 can further include Java-based classes for transforming incoming and outgoing messages from and to the common XML data model format. Where the adapter 110 includes an MQSeries Message Queue manager, the adapter 110 can be an IBM MQSeries Adapter®.

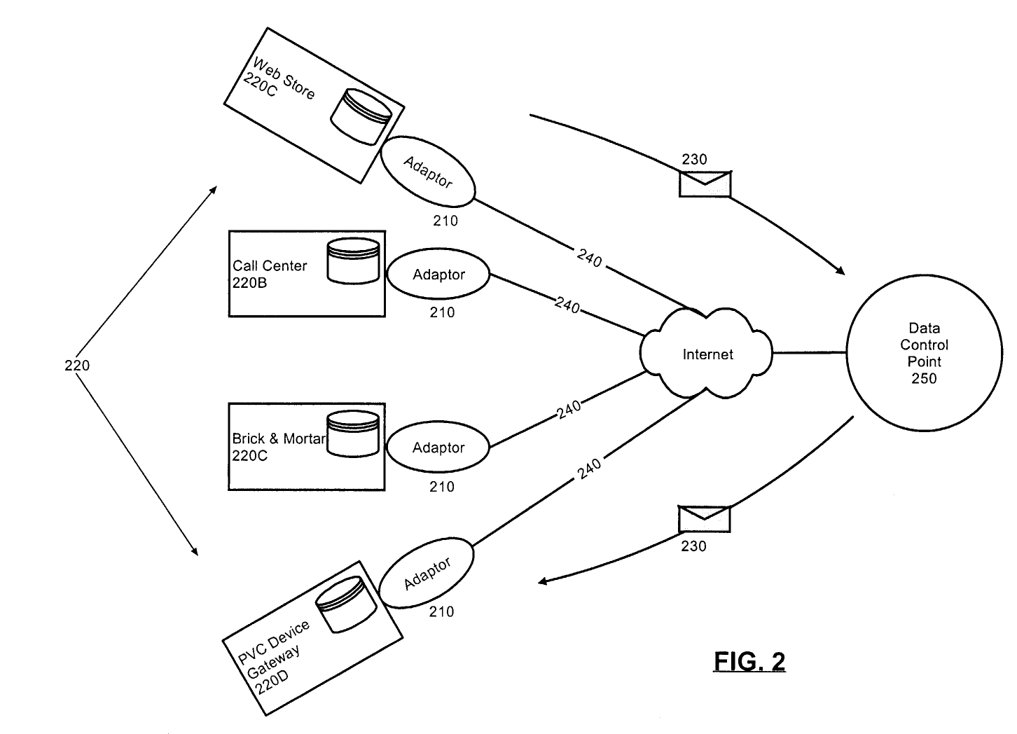

As shown in FIG. 1, where few retail channels 120 are included in the system 100, messages 140 can be transmitted directly between retail channels 120. Where many retail channels 120 are included in the system 100, however, it can be advantageous to provide a data control point which receives messages 140 from individual retail channels 120 and routes the messages 140 to other appropriate retail channels 120. In an alternative embodiment shown in FIG. 2, messages 240 are transmitted through a data control point 250. The data control point 250 can have any suitable structure for routing/serving messages 230 between retail channels 220 over communications links 240. For instance, a typical embodiment of a data control point 250 can include an MQ Series Integrator® Version 2 with or without its published and subscribed capability.

In operation, sets of data in the retail channels 220 can be identified as common. For instance, customer identification data, demographics, product information, and order history can be identified as common. For each IT system in a retail channel, an associated adapter 210 can intercept messages internal to the IT system to modify the data identified as common. Subsequently, the adapter 210 can extract from the intercepted messages the pertinent data with which the adapter 210 can reformat the extracted pertinent data in an XML message 230.

Once the XML message 230 has been suitably reformatted in an XML message 230, the XML message 230 can be forwarded to the data control point 250 in which the XML message 230 can be queued for transmission to subscribing retail IT systems in different retail channels 220. Adapters 210 also can receive XML messages 230 from the data control point 250. Upon receipt, the adapter 210 can parse the XML message 230 and extract therefrom the pertinent data. Depending upon the XML message 230, the adapter 210 also can format a corresponding message in accordance with the XML message 230 which can be inserted into the message queue of the retail IT system. In this way, data processing which has originated in other retail channels 220 can be processed in a particular retail channel 220 as if the processing originated in the particular retail channel 220.

The present invention permits the sharing of data to enable a wide variety of business processes. One such process is the creation and modification of customer relationship information such as name, address, preferred store, preferred contact mechanism, and the like. The creation and modification can occur at any channel touch point and the information subsequently becomes available for use at any other channel. Also, the system permits the creation and/or change of sales transaction data such as items sold, item price, loyalty points accumulated, and the like. This information can be input at any channel and also become subsequently available at any other channel. Further, distributed customer relationship information and sales transaction data enables multi-channel business processes such as:

1. shop the Web; pickup at local store; pay at store (POS);

2. shop at store kiosks; pay at store (POS); home delivery;

3. return home-delivered items (from Web or call center transactions) to a local store;

4. query order status from any touch point;

5. use loyalty points accumulated on any channel for purchases via any other channel

The present invention can be realized in hardware, software, or a combination of hardware and software. Moreover, the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which when loaded in a computer system is able to carry out these methods.

Computer program means or computer program in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A method for integrated multi-channel retailing, comprising the steps of:
associating a plurality of message adaptors with a plurality of retail integrated technology (IT) systems for processing common data in a plurality of retail channels, wherein each said message adaptor has a corresponding retail IT system, said association forming a peer-to-peer network;
intercepting in said message adaptors data processing messages generated in said corresponding retail IT systems;
converting in said message adaptors said intercepted data processing messages to a common message format and forwarding each converted data processing message to others of said retail IT systems; and,
receiving said forwarded data processing messages in said message adaptors, converting said received messages to a message format which can be processed in said corresponding retail IT systems, and forwarding said converted messages to said corresponding retail IT systems.

2. The method of claim 1, wherein said common message format is a format based upon a user definable mark-up language.

3. The method of claim 2, wherein said user definable mark-up language is the extensible markup language (XML).

4. The method of claim 1, wherein said step of forwarding messages which have been formatted in a common message format comprises the steps of:
forwarding each converted data processing message to a data control point; and,
routing said forwarded messages in said data control point to said others of said retail IT systems.

5. The method of claim 1, further comprising the step of queuing said intercepted messages in message queues in said message adaptors prior to converting said messages to a common data format.

6. The method of claim 1, further comprising the step of queuing said converted messages in message queues in said message adaptors prior to forwarding said messages to said others of said retail IT systems.

7. A machine readable storage having stored thereon a computer program for integrating multi-channel retailing, said computer program having a plurality of code sections executable by a machine for causing the machine to perform the steps of:
associating a plurality of message adaptors with a plurality of retail integrated technology (IT) systems for processing common data in a plurality of retail channels, wherein each said message adaptor has a corresponding retail IT system, said association forming a peer-to-peer network;
intercepting in said message adaptors data processing messages generated in said corresponding retail IT systems;
converting in said message adaptors said intercepted data processing messages to a common message format and forwarding each converted data processing message to others of said retail IT systems; and,
receiving said forwarded data processing messages in said message adaptors, converting said received messages to a message format which can be processed in said corresponding retail IT systems, and forwarding said converted messages to said corresponding retail IT systems.

8. The machine readable storage of claim 7, wherein said common message format is a format based upon a user definable mark-up language.

9. The machine readable storage of claim 8, wherein said user definable mark-up language is the extensible markup language (XML).

10. The machine readable storage of claim 7, wherein said step of forwarding messages which have been formatted in a common message format comprises the steps of:
forwarding each converted data processing message to a data control point; and,
routing said forwarded messages in said data control point to said others of said retail IT systems.

11. The machine readable storage of claim 7, further comprising the step of queuing said intercepted messages in message queues in said message adaptors prior to converting said messages to a common data format.

12. The machine readable storage of claim 7, further comprising the step of queuing said converted messages in message queues in said message adaptors prior to forwarding said messages to said others of said retail IT systems.

13. A method for integrated multi-channel retailing, comprising the steps of:
intercepting data processing messages in a retail information technology (IT) system for use in one type of retail channel;
formatting data in said intercepted messages using a user-definable markup language, and asynchronously communicating said formatted data to at least one other retail IT system for use in at least one other type of retail channel; and
receiving asynchronously communicated formatted data from at least one other retail IT system, converting said received formatted data to a format which can be processed in said retail IT system for use in said one type of retail channel.

14. The method of claim 13, wherein said user definable markup language is the extensible markup language (XML).

15. The method of claim 13, wherein said asynchronously communicating step comprises the steps of:
asynchronously forwarding each converted data processing message to a data control point; and,
asynchronously routing said forwarded messages in said data control point to said others of said retail IT systems.

16. The method of claim 13, wherein said step of asynchronously communicating said formatted data to at least one other retail IT system for use in at least one other type of retail channel step comprises the step of:
queuing said formatted messages in a message queue; and,
incrementally forwarding each said queued messages to said others of said retail IT systems.

17. A machine readable storage having stored thereon a computer program for integrating multi-channel retailing, said computer program having a plurality of code sections executable by a machine for causing the machine to perform the steps of:
intercepting data processing messages in a retail information technology (IT) system for use in one type of retail channel;
formatting data in said intercepted messages using a user-definable markup language, and asynchronously communicating said formatted data to at least one other retail IT system for use in at least one other type of retail channel; and
receiving asynchronously communicated formatted data from at least one other retail IT system, converting said received formatted data to a format which can be processed in said retail IT system for use in said one type of retail channel.

18. The machine readable storage of claim 17, wherein said user definable markup language is the extensible markup language (XML).

19. The machine readable storage of claim 17, wherein said asynchronously communicating step comprises the steps of:
asynchronously forwarding each converted data processing message to a data control point; and,
asynchronously routing said forwarded messages in said data control point to said others of said retail IT systems.

20. The machine readable storage of claim 17, wherein said step of asynchronously communicating said formatted data to at least one other retail IT system for use in at least one other type of retail channel step comprises the steps of:
queuing said formatted messages in a message queue; and,
incrementally forwarding each said queued messages to said others of said retail IT systems.

21. A method for integrated multi-channel retailing, comprising the steps of:
detecting a modification to common data in a retail information technology (IT) system configured for use in a retail channel;
formatting a message encapsulating said detected modification to said common data, and forwarding said formatted message to other retail IT systems configured for use in other retail channels; and,
receiving formatted messages which encapsulate modifications to common data, extracting said common data from said formatted message, formatting said extracted data to a format which can be processed in said retail IT system configured for use in said one type of retail channel, and forwarding said formatted data to said retail IT system.

22. A machine readable storage having stored thereon a computer program for integrating multi-channel retailing, said computer program having a plurality of code sections executable by a machine for causing the machine to perform the steps of:
detecting a modification to common data in a retail information technology (IT) system configured for use in a retail channel;
formatting a message encapsulating said detected modification to said common data, and forwarding said formatted message to other retail IT systems configured for use in other retail channels; and,
receiving formatted messages which encapsulate modifications to common data, extracting said common data from said formatted message, formatting said extracted data to a format which can be processed in said retail IT system configured for use in said one type of retail channel, and forwarding said formatted data to said retail IT system.
